(19) United States
(12) Patent Application Publication
(10) Pub. No.: US 2025/0246043 A1
(43) Pub. Date: Jul. 31, 2025

(54) METHODS AND SYSTEMS FOR FACILITATING PERSONALIZING A GAMEPLAY

(71) Applicant: Igor Solomatin, Limassol (CY)

(72) Inventor: Igor Solomatin, Limassol (CY)

(21) Appl. No.: 18/423,320

(22) Filed: Jan. 26, 2024

(51) Int. Cl. G07F 17/32; G06Q 20/42; G06Q 30/0601

(52) U.S. Cl. CPC G07F 17/3227; G06Q 20/42; G06Q 30/0603; G07F 17/3237; G07F 17/3241; G07F 17/3293

(57) ABSTRACT

Disclosed herein is a method of facilitating personalizing a gameplay. Accordingly, the method may include receiving a game request from at least one owner device associated with a game space owner, generating at least one gaming user interface based on the game request, obtaining at least one personalization information associated with at least one of the game space owner and at least one player, generating at least one non fungible token record representing at least one non fungible token associated with the plurality of game assets, generating a personalized game space data based on the at least one non fungible token record, transmitting the personalized game space data to the at least one owner device, and storing the personalized game space data in a distributed ledger.

### FIELD OF THE INVENTION

Generally, the present disclosure relates to the field of data processing. More specifically, the present disclosure relates to methods and systems for facilitating personalizing a gameplay.

### BACKGROUND OF THE INVENTION

The field of data processing is technologically important to several industries, business organizations, and/or individuals. In particular, the use of data processing is prevalent for personalizing a gameplay.

Existing techniques for personalizing a gameplay are deficient with regard to several aspects. For instance, current technologies struggle to retain players long-term, as the gaming experience can become monotonous without new and engaging features. Players in traditional settings are just participants with no sense of ownership or investment in the conventional platform.

Furthermore, current technologies, while successful in providing basic poker gameplay, lack the depth and personalization that modern players seek. Further, current technologies offer limited engagement beyond the game itself and don't leverage emerging technologies like blockchain and NFTs to enhance the user experience.

In the realm of online gaming, particularly in the sector of online poker, there exists a notable gap between the capabilities of traditional platforms and the evolving expectations of modern players. Historically, online poker platforms have been successful in delivering the fundamental aspects of poker game play. However, current technologies often fall short of providing a deeper, more immersive experience that extends beyond the basic mechanics of the game.

A key limitation of conventional platforms is the lack of personalization and depth. While basic functionalities are well-covered, the conventional platforms do not fully engage players in a manner that aligns with the evolving digital landscape. This shortfall is particularly evident in the absence of advanced technological integrations such as blockchain and Non-Fungible Tokens (NFTs), which have shown significant potential in enhancing user experiences across various digital platforms.

Therefore, there is a need for improved methods and systems for facilitating personalizing the gameplay that may overcome one or more of the above-mentioned problems and/or limitations.

### SUMMARY OF THE INVENTION

This summary is provided to introduce a selection of concepts in a simplified form, that are further described below in the Detailed Description. This summary is not intended to identify key features or essential features of the claimed subject matter. Nor is this summary intended to be used to limit the claimed subject matter's scope.

Disclosed herein is a method of facilitating personalizing a gameplay, in accordance with some embodiments. Accordingly, the method may include receiving, using a communication device, a game request from at least one owner device associated with a game space owner. Further, the game space owner owns a game space for allowing playing of a game. Further, the method may include generating, using a processing device, at least one gaming user interface based on the game request. Further, the at least one gaming user interface presents the game space to the game space owner. Further, the game space may include a virtual representation of the game. Further, the virtual representation may include a plurality of game assets. Further, the method may include obtaining, using the processing device, at least one personalization information associated with at least one of the game space owner and at least one player. Further, the at least one player plays the game in the game space. Further, the method may include generating, using the processing device, at least one non fungible token record representing at least one non fungible token associated with the plurality of game assets. Further, the at least one non fungible token record may include a personalized digital representation of the plurality of game assets. Further, the method may include generating, using the processing device, a personalized game space data based on the at least one non fungible token record. Further, the personalized game space data corresponds to a personalized game space that may include the plurality of game assets customized according to the at least one personalization information. Further, the method may include transmitting, using the communication device, the personalized game space data to the at least one owner device. Further, the method may include storing, using a storage device, the personalized game space data in a distributed ledger.

Further disclosed herein is a system of facilitating personalizing a gameplay, in accordance with some embodiments. Accordingly, the system may include a communication device configured for receiving a game request from at least one owner device associated with a game space owner. Further, the game space owner owns a game space for allowing playing of a game. Further, the communication device may be configured for transmitting a personalized game space data to the at least one owner device. Further, the system may include a processing device communicatively coupled with the communication device. Further, the processing device may be configured for generating at least one gaming user interface based on the game request. Further, the at least one gaming user interface presents the game space to the first user. Further, the game space may include a virtual representation of the game. Further, the virtual representation may include a plurality of game assets. Further, the processing device may be configured for obtaining at least one personalization information associated with at least one of the game space owner and at least one player. Further, the at least one player plays the game in the game space. Further, the processing device may be configured for generating at least one non fungible token record representing at least one non fungible token associated with the plurality of game assets. Further, the at least one non fungible token record may include a personalized digital representation of the plurality of game assets. Further, the processing device may be configured for generating, using the processing device, the personalized game space data based on the at least one non fungible token record. Further, the personalized game space data corresponds to a personalized game space that may include the plurality of game assets customized according to the at least one personalization information. Further, the system may include a storage device communicatively coupled with the processing device. Further, the storage device may be configured for storing the personalized game space data in a distributed ledger.

Both the foregoing summary and the following detailed description provide examples and are explanatory only. Accordingly, the foregoing summary and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the applicants. The applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure.

FIG. 1 is an illustration of an online platform consistent with various embodiments of the present disclosure.

FIG. 2 is a flow chart of a method 200 of facilitating personalizing a gameplay, in accordance with some embodiments.

FIG. 3 is a flow chart of a method 300 of facilitating personalizing a gameplay, in accordance with some embodiments.

FIG. 4 is a flow chart of a method 400 of facilitating personalizing a gameplay, in accordance with some embodiments.

FIG. 5 is a flow chart of a method 500 of facilitating personalizing a gameplay, in accordance with some embodiments.

FIG. 6 is a flow chart of a method 600 of facilitating personalizing a gameplay, in accordance with some embodiments.

FIG. 7 is a flow chart of a method 700 of facilitating personalizing a gameplay, in accordance with some embodiments.

FIG. 8 is a flow chart of a method 800 of facilitating personalizing a gameplay, in accordance with some embodiments.

FIG. 9 is a flow chart of a method 900 of facilitating personalizing a gameplay, in accordance with some embodiments.

FIG. 10 is a block diagram of a system 1000 of facilitating personalizing a gameplay, in accordance with some embodiments.

FIG. 11 is a block diagram of the system 1000 of facilitating personalizing the gameplay, in accordance with some embodiments.

FIG. 12 is a block diagram of the system 1000 of facilitating personalizing the gameplay, in accordance with some embodiments.

FIG. 13 is a block diagram of the system 1000 of facilitating personalizing the gameplay, in accordance with some embodiments.

FIG. 14 is a block diagram of the system 1000 of facilitating personalizing the gameplay, in accordance with some embodiments.

FIG. 15 is a block diagram of a computing device for implementing the methods disclosed herein, in accordance with some embodiments.

### DETAIL DESCRIPTIONS OF THE INVENTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim limitation found herein and/or issuing here from that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present disclosure. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term-differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the claims found herein and/or issuing here from. The present disclosure contains headers. It should be understood that these headers are used as references and are not to be construed as limiting upon the subjected matter disclosed under the header.

The present disclosure includes many aspects and features. Moreover, while many aspects and features relate to, and are described in the context of methods and systems of facilitating personalizing a gameplay, embodiments of the present disclosure are not limited to use only in this context.

In general, the method disclosed herein may be performed by one or more computing devices. For example, in some embodiments, the method may be performed by a server computer in communication with one or more client devices over a communication network such as, for example, the Internet. In some other embodiments, the method may be performed by one or more of at least one server computer, at least one client device, at least one network device, at least one sensor, and at least one actuator. Examples of the one or more client devices and/or the server computer may include, a desktop computer, a laptop computer, a tablet computer, a personal digital assistant, a portable electronic device, a wearable computer, a smart phone, an Internet of Things (IoT) device, a smart electrical appliance, a video game console, a rack server, a super-computer, a mainframe computer, mini-computer, micro-computer, a storage server, an application server (e.g. a mail server, a web server, a real-time communication server, an FTP server, a virtual server, a proxy server, a DNS server, etc.), a quantum computer, and so on. Further, one or more client devices and/or the server computer may be configured for executing a software application such as, for example, but not limited to, an operating system (e.g. Windows, Mac OS, Unix, Linux, Android, etc.) in order to provide a user interface (e.g. GUI, touch-screen based interface, voice based interface, gesture based interface, etc.) for use by the one or more users and/or a network interface for communicating with other devices over a communication network. Accordingly, the server computer may include a processing device configured for performing data processing tasks such as, for example, but not limited to, analyzing, identifying, determining, generating, transforming, calculating, computing, compressing, decompressing, encrypting, decrypting, scrambling, splitting, merging, interpolating, extrapolating, redacting, anonymizing, encoding and decoding. Further, the server computer may include a communication device configured for communicating with one or more external devices. The one or more external devices may include, for example, but are not limited to, a client device, a third party database, a public database, a private database, and so on. Further, the communication device may be configured for communicating with the one or more external devices over one or more communication channels. Further, the one or more communication channels may include a wireless communication channel and/or a wired communication channel. Accordingly, the communication device may be configured for performing one or more of transmitting and receiving of information in electronic form. Further, the server computer may include a storage device configured for performing data storage and/or data retrieval operations. In general, the storage device may be configured for providing reliable storage of digital information. Accordingly, in some embodiments, the storage device may be based on technologies such as, but not limited to, data compression, data backup, data redundancy, deduplication, error correction, data finger-printing, role based access control, and so on.

Further, one or more steps of the method disclosed herein may be initiated, maintained, controlled, and/or terminated based on a control input received from one or more devices operated by one or more users such as, for example, but not limited to, an end user, an admin, a service provider, a service consumer, an agent, a broker and a representative thereof. Further, the user as defined herein may refer to a human, an animal, or an artificially intelligent being in any state of existence, unless stated otherwise, elsewhere in the present disclosure. Further, in some embodiments, the one or more users may be required to successfully perform authentication in order for the control input to be effective. In general, a user of the one or more users may perform authentication based on the possession of a secret human readable secret data (e.g. username, password, passphrase, PIN, secret question, secret answer etc.) and/or possession of a machine readable secret data (e.g. encryption key, decryption key, bar codes, etc.) and/or possession of one or more embodied characteristics unique to the user (e.g. biometric variables such as, but not limited to, fingerprint, palm-print, voice characteristics, behavioral characteristics, facial features, iris pattern, heart rate variability, evoked potentials, brain waves, and so on) and/or possession of a unique device (e.g. a device with a unique physical and/or chemical and/or biological characteristic, a hardware device with a unique serial number, a network device with a unique IP/MAC address, a telephone with a unique phone number, a smartcard with an authentication token stored thereupon, etc.). Accordingly, the one or more steps of the method may include communicating (e.g. transmitting and/or receiving) with one or more sensor devices and/or one or more actuators in order to perform authentication. For example, the one or more steps may include receiving, using the communication device, the secret human readable data from an input device such as, for example, a keyboard, a keypad, a touch-screen, a microphone, a camera, and so on. Likewise, the one or more steps may include receiving, using the communication device, the one or more embodied characteristics from one or more biometric sensors.

Further, one or more steps of the method may be automatically initiated, maintained, and/or terminated based on one or more predefined conditions. In an instance, the one or more predefined conditions may be based on one or more contextual variables. In general, the one or more contextual variables may represent a condition relevant to the performance of the one or more steps of the method. The one or more contextual variables may include, for example, but are not limited to, location, time, identity of a user associated with a device (e.g. the server computer, a client device, etc.) corresponding to the performance of the one or more steps, environmental variables (e.g. temperature, humidity, pressure, wind speed, lighting, sound, etc.) associated with a device corresponding to the performance of the one or more steps, physical state and/or physiological state and/or psychological state of the user, physical state (e.g. motion, direction of motion, orientation, speed, velocity, acceleration, trajectory, etc.) of the device corresponding to the performance of the one or more steps and/or semantic content of data associated with the one or more users. Accordingly, the one or more steps may include communicating with one or more sensors and/or one or more actuators associated with the one or more contextual variables. For example, the one or more sensors may include, but are not limited to, a timing device (e.g. a real-time clock), a location sensor (e.g. a GPS receiver, a GLONASS receiver, an indoor location sensor etc.), a biometric sensor (e.g. a fingerprint sensor), an environmental variable sensor (e.g. temperature sensor, humidity sensor, pressure sensor, etc.) and a device state sensor (e.g. a power sensor, a voltage/current sensor, a switch-state sensor, a usage sensor, etc. associated with the device corresponding to performance of the or more steps).

Further, the one or more steps of the method may be performed one or more number of times. Additionally, the one or more steps may be performed in any order other than as exemplarily disclosed herein, unless explicitly stated otherwise, elsewhere in the present disclosure. Further, two or more steps of the one or more steps may, in some embodiments, be simultaneously performed, at least in part. Further, in some embodiments, there may be one or more time gaps between performance of any two steps of the one or more steps.

Further, in some embodiments, the one or more predefined conditions may be specified by the one or more users. Accordingly, the one or more steps may include receiving, using the communication device, the one or more predefined conditions from one or more devices operated by the one or more users. Further, the one or more predefined conditions may be stored in the storage device. Alternatively, and/or additionally, in some embodiments, the one or more predefined conditions may be automatically determined, using the processing device, based on historical data corresponding to performance of the one or more steps. For example, the historical data may be collected, using the storage device, from a plurality of instances of performance of the method. Such historical data may include performance actions (e.g. initiating, maintaining, interrupting, terminating, etc.) of the one or more steps and/or the one or more contextual variables associated therewith. Further, machine learning may be performed on the historical data in order to determine the one or more predefined conditions. For instance, machine learning on the historical data may determine a correlation between one or more contextual variables and performance of the one or more steps of the method. Accordingly, the one or more predefined conditions may be generated, using the processing device, based on the correlation.

Further, one or more steps of the method may be performed at one or more spatial locations. For instance, the method may be performed by a plurality of devices interconnected through a communication network. Accordingly, in an example, one or more steps of the method may be performed by a server computer. Similarly, one or more steps of the method may be performed by a client computer. Likewise, one or more steps of the method may be performed by an intermediate entity such as, for example, a proxy server. For instance, one or more steps of the method may be performed in a distributed fashion across the plurality of devices in order to meet one or more objectives. For example, one objective may be to provide load balancing between two or more devices. Another objective may be to restrict a location of one or more of an input data, an output data and any intermediate data therebetween corresponding to one or more steps of the method. For example, in a client-server environment, sensitive data corresponding to a user may not be allowed to be transmitted to the server computer. Accordingly, one or more steps of the method operating on the sensitive data and/or a derivative thereof may be performed at the client device.

### Overview

The present disclosure describes methods and systems of facilitating personalizing a gameplay. Further, the disclosed system may be associated with an NFT-based model of table ownership and revenue generation by players in a poker room. Further, the disclosed system may be an NFT-based system of table ranking and seating of players in a poker room. Further, the disclosed system may provide NFT-based decor elements to increase table ranking. Further, the disclosed system may be configured for an automated table selection system based on room ranking.

Further, the disclosed system may be configured for performing NFT-Based customization. Further, the disclosed system utilizes NFTs to allow players to own, customize, and personalize their poker tables and rooms. This deep level of customization goes beyond avatars or interface tweaks. Further, the disclosed system may be configured for allowing players to own a part of a platform (through table ownership) associated with the disclosed system. Further, the disclosed system creates a new layer of engagement and investment.

Further, the disclosed system may use NFTs for decor elements like table settings, chairs, and room ambiance, which creates a dynamic and interactive environment that responds to player choices.

The present disclosure describes an economic ecosystem where players can buy, sell, or trade NFTs, adding a strategic economic layer to the poker experience. Further, the disclosed system may facilitate integration of such technologies to revolutionize the online poker experience, offering a level of engagement, personalization, and interactivity.

Further, the disclosed system utilizes Non-Fungible Tokens (NFTs) to revolutionize the online poker experience. By incorporating NFTs, we enable players to own, customize, and personalize their poker tables and rooms. This approach transcends traditional personalization options, such as avatars and interface tweaks, by offering a profound level of individualization and control over the gaming environment.

Further, the players can use NFTs to upgrade and enhance their rooms, impacting the overall rating of their space. This rating is not merely cosmetic; it plays a crucial role in how the platform's matchmaking system operates. Rooms with higher ratings, signifying more extensive customization and investment, are more likely to be assigned a greater influx of players. This direct correlation between room enhancement and player traffic introduces a dynamic aspect to the gaming experience. The higher a room's rating, the more frequent its engagement, leading to more hands being played, and consequently, a higher rake generated compared to base-level rooms.

The integration of blockchain technology in this model serves multiple purposes. Firstly, it provides a secure and transparent framework for the ownership, trading, and upgrading of NFTs. This security is paramount in maintaining the integrity and trust of the gaming environment. Secondly, blockchain technology facilitates a novel revenue model. By granting players ownership of their tables through NFTs, the platform opens up new avenues for player engagement and investment. This ownership isn't merely symbolic; it's a tangible stake in the platform, where players benefit directly from the activity at their tables. Such a model creates a sense of investment and belonging among players, fostering a more engaged and committed user base.

The integration of NFTs and blockchain technology marks a significant shift from the traditional models of online poker platforms that align with the current trends in digital technology, offering an experience that is rich, personalized, and deeply engaging, thus addressing the previously identified gaps in the online poker market.

Further, the disclosed system may provide a novel ownership and revenue model for online poker. Further, the disclosed system may allow the players to acquire ownership of virtual poker tables. This acquisition is facilitated through a process of direct purchase, leveraging the capabilities of blockchain technology and the unique attributes of Non-Fungible Tokens (NFTs).

Further, the disclosed system may allow the players to rent a room through a direct transaction, facilitated via an in-game store or a dedicated marketplace within the platform. Further, each room, while not an NFT itself, provides the foundation for various NFT-based enhancements that players can acquire and apply.

Within their rented room, the players have the freedom to customize a multitude of elements, transforming the space into a personalized poker environment. These elements include:
Table layout: Design and aesthetic of the poker table.
Cards layout: Custom designs and themes for playing cards.
Chips layout: Unique styles and colors for poker chips.
Dealer avatar: Selection of virtual dealer avatars, each with distinct characteristics.
Walls layout: Decorative themes and artworks for the room's walls.
Floor layout: Various flooring designs to complement the room's ambiance.
Additional decor: Including customizable paints, sculptures, and flowers, to enhance the aesthetic appeal of the room.

Further, the players do not merely rent the decor elements for their rooms, the players own these elements in the form of NFTs. This ownership persists even after the rental period of the room has ended.

Further, the ownership of the NFTs is recorded on the blockchain, providing a permanent, immutable record of ownership. This ensures that the players retain full rights to their purchased decor items, irrespective of their current rental status.

Further, the disclosed system may be configured for trading of the decor NFTs. Further, the players are empowered with the flexibility to trade their decor NFTs. This may occur either on an internal marketplace within the platform or on external third-party platforms.

The blockchain technology, incorporated in the disclosed system, underpinning these NFTs facilitates secure and transparent transactions, allowing players to buy, sell, or trade their decor items with confidence and ease.

Further, the trading mechanism introduces an additional layer of strategy and economic interaction within the platform. Further, the players may invest in rare or desirable decor items, potentially trading them for profit or utilizing them to enhance the appeal and profitability of their rooms.

Further, renting a room entitles the player to a share of the rake generated from games played within their customized space. This share is influenced by the level of customization and the popularity of the room. The room becomes a reflection of the player's style and preferences, creating a more engaging and personalized poker experience for both the room owner and visiting players.

Further, the disclosed system may be designed to enhance player engagement and provide a unique gaming experience. The disclosed system assigns a rating to each poker table based on various factors, primarily influenced by the NFT decor elements used for customization. The system aims to create a competitive, engaging, and aesthetically diverse gaming environment.

Further, the tables are rated for their visual appeal, considering the style, quality, and thematic consistency of the NFT decor. Further, the disclosed system encourages table owners to invest in appealing decor to attract players.

Further, the tables featuring rare or high-value NFTs receive higher ratings. Further, the disclosed system promotes a marketplace for unique and sought-after decor items.

The disclosed poker table ranking system may be configured to drive innovation and engagement. Further, the disclosed system leverages the potential of NFTs to transform the online poker experience, making it more interactive, personalized, and enjoyable for players and table owners alike.

Further, the disclosed system may be configured to provide deep personalization options via NFT-based decor elements that allow players to customize their poker rooms and tables. This goes beyond the standard personalization features (like avatars) in traditional platforms, creating a more immersive and engaging player experience. Further, the disclosed system may provide ownership and investment opportunities. Further, the players can rent rooms and own NFT decor elements, offering a sense of ownership and investment in the platform. Further, the system may transform the players from mere participants to stakeholders in the gaming environment, fostering a deeper connection and long-term engagement with the platform.

Further, the disclosed system may facilitate revenue sharing from a rake generated at player-customized tables. Further, the disclosed system may allow the players to earn real financial rewards, adding an incentive layer to the gaming experience.

Further, the introduction of a dynamic table ranking system influenced by NFT decor and upgrades creates an ever-changing gaming landscape, encouraging continuous engagement and strategic thinking from players.

Further, the use of blockchain technology for secure transactions and ownership verification of NFTs ensures transparency, security, and uniqueness in the gaming experience, enhancing player trust and satisfaction.

Further, the disclosed system may provide a secondary market for NFT trading. Further, the disclosed system may allow the players to trade their NFTs on internal or external marketplaces. Further, trading of the NFTs opens up an additional economic layer where players can engage in strategic buying, selling, and trading, adding depth to the platform's economy.

Further, the disclosed system may allow the player to create an account and log in for authentication. Further, the disclosed system may be configured for performing verification of user identity and age for security checks.

Further, the disclosed system may establish a secure connection with the poker room servers. Further, the disclosed system may be configured for table creation and enhancement with NFTs. The process of table creation and enhancement through NFTs is a unique aspect of the online poker room provided by the disclosed system, offering regular users an opportunity to become table owners and earn a share of the rake. Further, regular users may create their a poker table associated with the users within the platform, transitioning from players to table owners.

Further, during creation, the table owners may customize basic aspects of the table such as game type, limits, and initial design.

Further, the disclosed system may allow investment in NFTs. Further, the disclosed system may provide table owners with access to a marketplace where the table owners may purchase decorative NFTs specifically designed for poker tables. Further, the table owners may select from a variety of NFTs, each offering different aesthetic enhancements and potential ranking boosts. Further, the disclosed system may be configured for enhancing tables with NFTs. Once purchased, the NFTs may be applied to the table, instantly upgrading its visual appeal and increasing its ranking. Further, the disclosed system may be configured for allowing the table owner to earn a share of the rake as a revenue from gameplay. As players engage in games at the enhanced table, the table owner earns a percentage of the rake generated from each pot. Further, the higher the table's ranking (that may be boosted by the NFTs), the potentially greater the share of the rake due to increased player attraction and game volume.

Further, the disclosed system may be associated with a software application. Further, the software application may provide a user interface. Further, the user interface may include a main lobby interface displaying various game options and features. Further, the disclosed system may be configured for allowing players to filter games by type, limits, and format. Further, the user interface may include an information display showing available game types, game limits, number of max players, and average pot size. Further, the disclosed system may allow game type selection by the player. Further, the players may select from various cash game options. Further, the disclosed system may provide options for different types of tournaments, such as Sit & Go, Multi-table, etc. Further, the disclosed system may allow the player to set betting limits for each round of betting. Further, the online poker game may include a maximum bet equal to the current pot size. Further, in some embodiments, the players can bet any amount of chips.

Further, the disclosed system may be configured for allowing the player to choose a table format such as heads-up (One-on-one gameplay), 6-Max: Tables with a maximum of 6 players, and 9-Max: Tables accommodating up to 9 players. Further, the disclosed system may automatically assign a seat to the player. Further, table ratings may influence player assignment. Further, the higher the table rating, the more often the system assigns players to available seats at that table. Further, the players who own the table may be encouraged to acquire and utilize the NFTs to boost their tables' rankings. This creates a competitive environment in which table owners seek to increase their table rating through improvements with NFT. In multi-table tournaments, the players may be moved to balance the number of players at each table. Further, the online poker may be associated with gameplay mechanics. Further, a virtual dealer distributes cards. Further, the players place bets according to the game rules. Further, the software application determines the winner based on hand rankings. Further, the players may exit the game at any time. Further, the disclosed system may provide options to re-enter the game (especially in tournaments). Further, the disclosed system may facilitate financial transactions associated with buy-ins and payouts. Further, the disclosed system may facilitate handling of chip purchases and winnings. Further, the disclosed system may ensure safe financial operations. Further, the disclosed system may provide customer support and help. Further, the disclosed system may provide assistance for gameplay, technical issues, and account management. Further, the disclosed system may be configured for providing resources for game rules and platform usage.

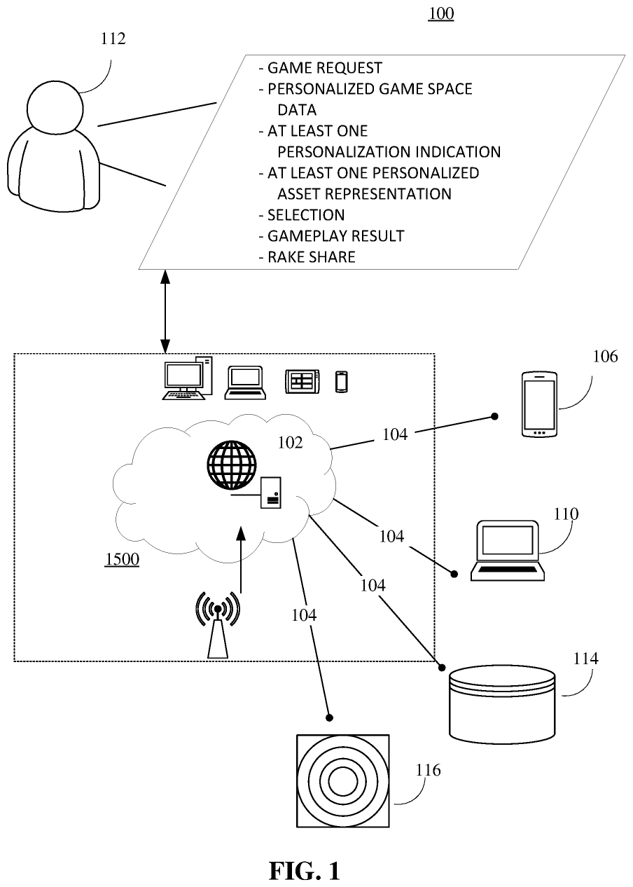

FIG. 1 is an illustration of an online platform 100 consistent with various embodiments of the present disclosure. By way of non-limiting example, the online platform 100 for facilitating personalizing a gameplay may be hosted on a centralized server 102, such as, for example, a cloud computing service. The centralized server 102 may communicate with other network entities, such as, for example, a mobile device 106 (such as a smartphone, a laptop, a tablet computer, etc.), other electronic devices 110 (such as desktop computers, server computers, etc.), databases 114, and sensors 116 over a communication network 104, such as, but not limited to, the Internet. Further, users of the online platform 100 may include relevant parties such as, but not limited to, end-users, administrators, service providers, service consumers, and so on. Accordingly, in some instances, electronic devices operated by the one or more relevant parties may be in communication with the platform.

A user 112, such as the one or more relevant parties, may access online platform 100 through a web based software application or browser. The web based software application may be embodied as, for example, but not be limited to, a website, a web application, a desktop application, and a mobile application compatible with a computing device 1500.

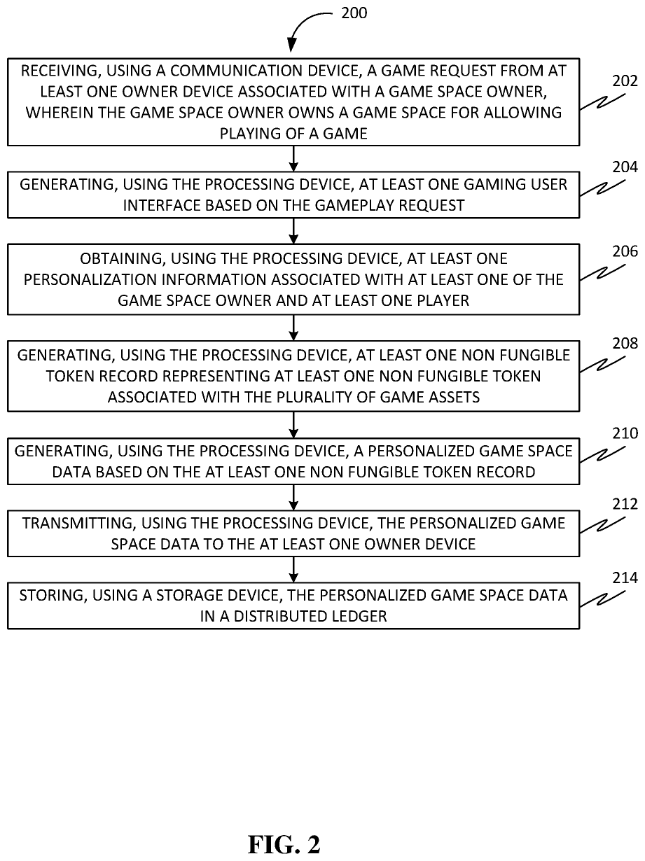

FIG. 2 is a flow chart of a method 200 of facilitating personalizing a gameplay, in accordance with some embodiments. Accordingly, at 202, the method 200 may include receiving, using a communication device (such as a communication device 1002), a game request from at least one owner device (such as at least one owner device 1102) associated with a game space owner. Further, the game space owner owns a game space for allowing playing of a game. Further, the game request may include owner credentials (such as an owner name, an owner address, an owner email, an owner identity card, etc.). Further, the at least one owner device may include a computing device, a client device, etc. Further, the game space owner may be an individual. Further, the game may include a poker game.

Further, at 204, the method 200 may include generating, using a processing device (such as a processing device 1004), at least one gaming user interface based on the game request. Further, the at least one gaming user interface presents the game space to the game space owner. Further, the game space may include a virtual representation of the game. Further, the virtual representation may include a plurality of game assets. Further, the game space may include a room. Further, the plurality of game assets may include a table characterized by a table layout (such as design and aesthetic of the table), cards characterized by custom designs and themes for playing cards, chips available in unique styles and colors), a dealer avatar associated with a dealer (each with distinct characteristics), walls available in decorative themes and artworks, floor, and additional decor (or décor) including customizable paints, sculptures, and flowers, to enhance the aesthetic appeal of the room. Further, at 206, the method 200 may include obtaining, using the processing device, at least one personalization information associated with at least one of the game space owner and at least one player. Further, the at least one player plays the game in the game space. Further, the at least one player may include an individual.

Further, at 208, the method 200 may include generating, using the processing device, at least one non fungible token record representing at least one non fungible token associated with the plurality of game assets. Further, the at least one non fungible token record may include a personalized digital representation of the plurality of game assets.

Further, at 210, the method 200 may include generating, using the processing device, a personalized game space data based on the at least one non fungible token record. Further, the personalized game space data corresponds to a personalized game space that may include the plurality of game assets customized according to the at least one personalization information. Further, the personalized game space data may include at least one user interface presenting the personalized game space.

Further, at 212, the method 200 may include transmitting, using the communication device, the personalized game space data to the at least one owner device. Further, the at least one owner device may include a smartphone, a tablet, a laptop, and so on.

Further, at 214, the method 200 may include storing, using a storage device (such as a storage device 1006), the personalized game space data in a distributed ledger.

Further, in some embodiments, the method 200 may include receiving, using the communication device, a player personalization indication associated with at least one of the plurality of game assets from at least one player device associated with the at least one player. Further, the player personalization indication indicates a willingness of the at least one player to customize the game space. Further, the method 200 may include retrieving, using the storage device, at least one personalized asset representation associated with at least one of the plurality of game assets based on the player personalization indication. Further, the method 200 may include transmitting, using the communication device, the at least one personalized asset representation to the at least one player device. Further, the method 200 may include receiving, using the communication device, a player asset selection corresponding to the at least one personalized asset representation from the at least one player device. Further, the obtaining of the at least one personalization information is further based on the player asset selection.

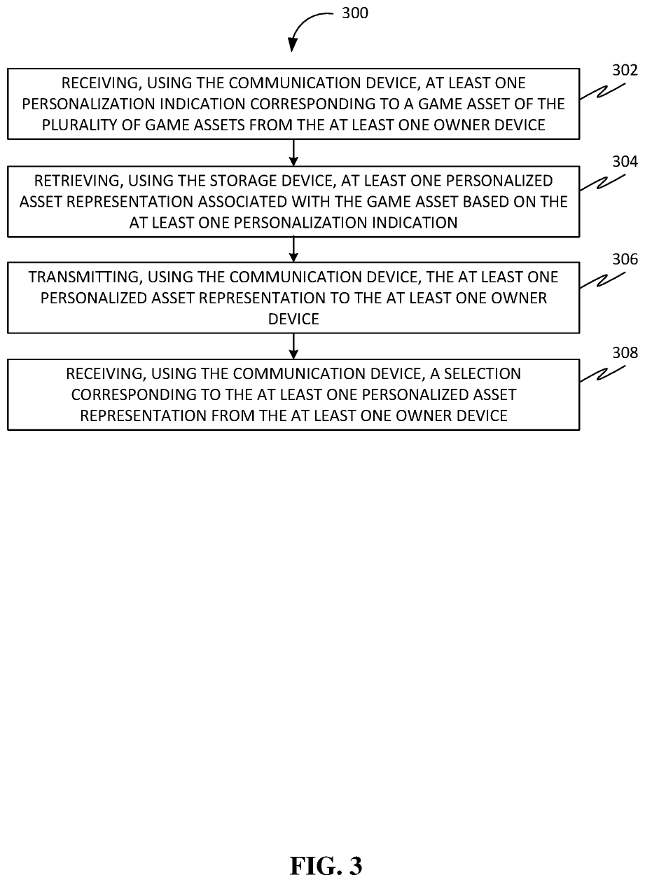

FIG. 3 is a flow chart of a method 300 of facilitating personalizing a gameplay, in accordance with some embodiments. Accordingly, at 302, the method 300 may include receiving, using the communication device, at least one personalization indication corresponding to a game asset of the plurality of game assets from the at least one owner device. Further, the at least one personalization indication may include a personalization information associated with the game asset. Further, the at least one personalization indication may include an asset selection corresponding to the game asset chosen (or selected) to be personalized by the at least one owner. Further, the at least one owner may want to personalize the game asset based on the at least one personalization indication. Further, the personalization information associated with the table may include a table layout such as design and aesthetic of the table. Further, the personalization information associated with the cards may include custom designs, colors, and themes for playing cards. Further, the personalization information associated with the chips may include unique chips styles and colors. Further, the personalization information associated with the dealer avatar may include distinct avatar characteristics such as facial characteristics, clothing, wearable accessories, etc. Further, the personalization information associated with the walls may include decorative themes and artworks. Further, the personalization information associated with the floor may include floor design, flooring material, etc. Further, the personalization information associated with the additional decor may include customizable paints, sculptures, and flowers, to enhance the aesthetic appeal of the room.

Further, at 304, the method 300 may include retrieving, using the storage device, at least one personalized asset representation associated with the game asset based on the at least one personalization indication. Further, the at least one personalization indication associated with the wall may include

Further, at 306, the method 300 may include transmitting, using the communication device, the at least one personalized asset representation to the at least one owner device.

Further, at 308, the method 300 may include receiving, using the communication device, a selection corresponding to the at least one personalized asset representation from the at least one owner device. Further, the obtaining of the at least one personalization information may be based on the selection.

Further, in some embodiments, the plurality of game assets may include at least one modifiable asset and at least one unmodifiable asset. Further, the at least one modifiable asset may include an asset that may be personalized by the game space owner. Further, the at least one unmodifiable asset may include an asset that may be available in a fixed state. Further, the fixed state indicates that the at least one unmodifiable asset can not be personalized by the game space owner. Further, the at least one modifiable asset may be converted into at least one fungible token by tokenizing the at least one modifiable asset. Further, the at least one unmodifiable asset may be converted into at least one non fungible token by tokenizing the at least one unmodifiable asset. Further, the plurality of game assets may be digital assets. Further, the tokenizing masks at least one characteristic of the at least one modifiable asset and the at least one unmodifiable asset with at least one token characteristic of the at least one modifiable asset and the at least one unmodifiable asset.

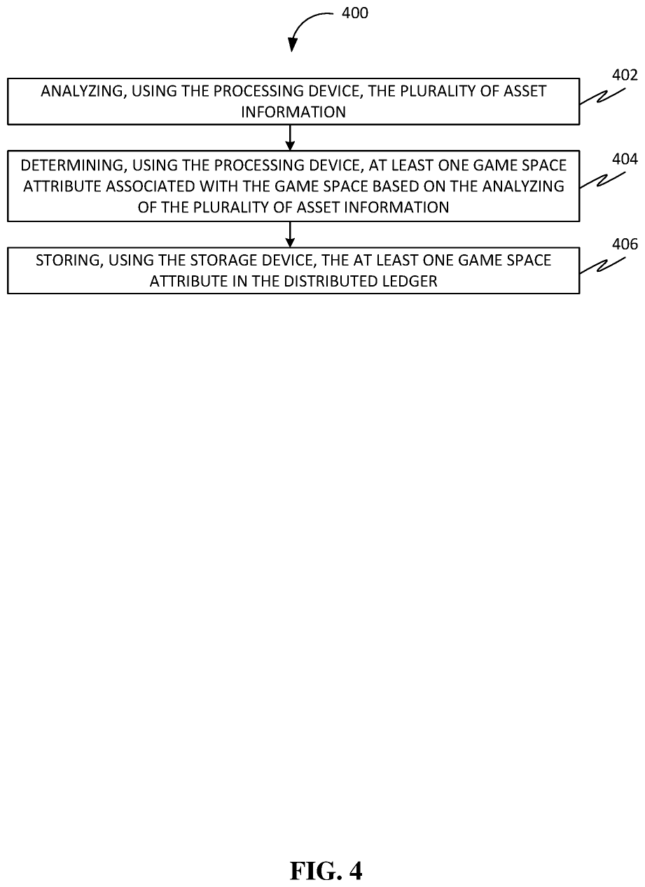

FIG. 4 is a flow chart of a method 400 of facilitating personalizing a gameplay, in accordance with some embodiments. Accordingly, the personalized game space data may include a plurality of asset information associated with each of the plurality of game assets. Further, the plurality of asset information may include the at least one non fungible token record. Further, the at least one non fungible token record may include a rarity information associated with each of the at least one non fungible token. Further, the rarity information may indicate a rarity of the at least one non fungible token. Further, the rarity determines the value of the at least one non fungible token. Further, in an embodiment, the at least one non fungible token refers to how common a specific NFT is within a collection. Further, the rarity refers to the uniqueness or scarcity of the at least one non-fungible token (NFT). Further, the plurality of asset information may represent an extent of personalizing of the plurality of game assets Further, the plurality of asset information may include the personalizing information associated with each of the plurality of game assets. Further, at 402, the method 400 may include analyzing, using the processing device, the plurality of asset information. Further, at 404, the method 400 may include determining, using the processing device, at least one game space attribute associated with the game space based on the analyzing of the plurality of asset information. Further, at 406, the method 400 may include storing, using the storage device, the at least one game space attribute in the distributed ledger. Further, the at least one game space attribute may include a ranking corresponding to the game space based on the extent of the personalizing of the plurality of game assets. Further, the game space may include a room. Further, the room may include at least one table to play the game. Further, the analyzing of the plurality of asset information may be based on at least one ranking criterion. Further, the at least one ranking criterion may include a score or quantifier corresponding to each of the plurality of game assets.

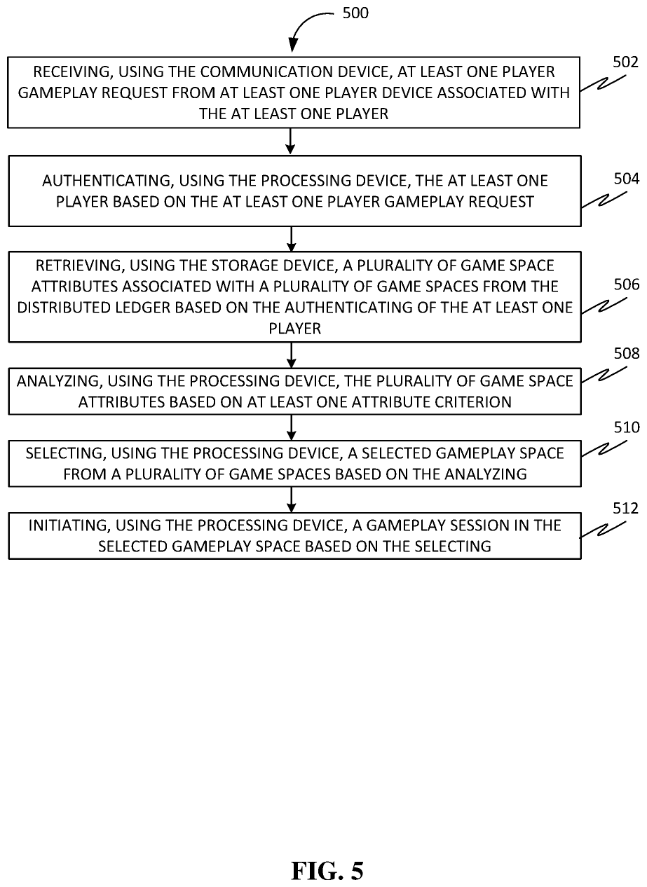

FIG. 5 is a flow chart of a method 500 of facilitating personalizing a gameplay, in accordance with some embodiments. Accordingly, at 502, the method 500 may include receiving, using the communication device, at least one player gameplay request from at least one player device (such as at least one player device 1202) associated with at least one player. Further, the at least one player gameplay request may include at least one player identifier. Further, the at least one player identifier may include a player name, player email address, a password, etc. Further, the at least one player gameplay request indicates a willingness of the at least one player to play the game. Further, at 504, the method 500 may include authenticating, using the processing device, the at least one player based on the at least one player gameplay request. Further, the authenticating of the at least one player may include verifying a player identity. Further, at 506, the method 500 may include retrieving, using the storage device, a plurality of game space attributes associated with a plurality of game spaces from the distributed ledger based on the authenticating of the at least one player. Further, each of the plurality of game space attributes represents a level of personalization of the each of the plurality of game spaces. Further, at 508, the me thod 500 may include analyzing, using the processing device, the plurality of game space attributes. Further, at 510, the method 500 may include selecting, using the processing device, a selected game space of a plurality of game spaces based on the analyzing. Further, at 512, the method 500 may include initiating, using the processing device, a gameplay session in the selected game space based on the selecting. Further, the gameplay session allows the at least one player to play the game in the selected game space.

Further, the analyzing of the plurality of game space attributes may include organizing the plurality of game spaces in a sequence based on at least one game space selection criterion. Further, the at least one game space selection criterion may include a ranking information associated with a rank to be assigned to each of the plurality of game spaces.

Further, in some embodiments, the method 500 may include obtaining, using the processing device, an availability indication associated with each of the plurality of game spaces. Further, the availability indication may indicate whether a game session is being held in the game space of the plurality of game spaces. Further, the availability indication may be obtained in real time. Further, the selecting of the selected game space may be based on the availability indication.

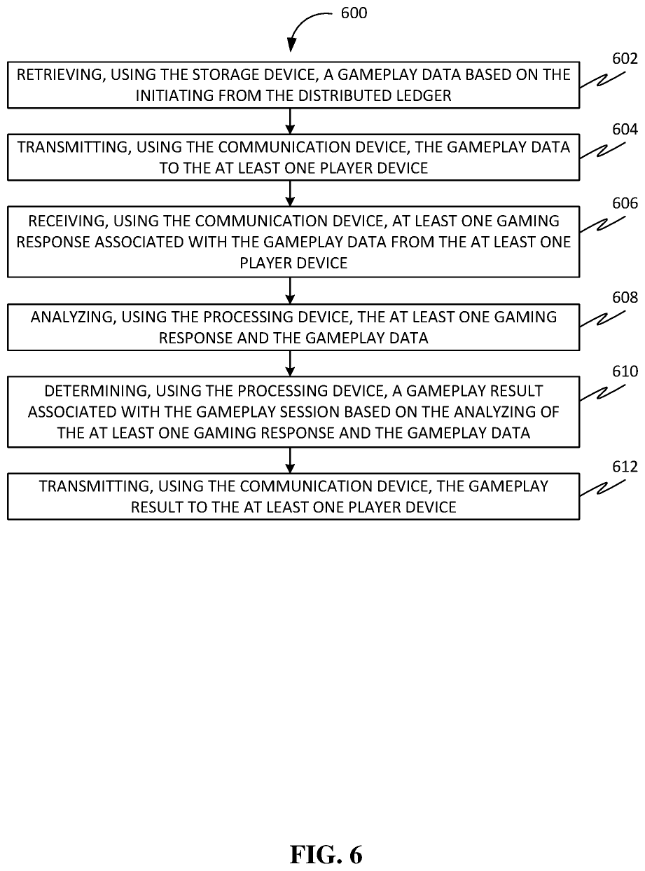

FIG. 6 is a flow chart of a method 600 of facilitating personalizing a gameplay, in accordance with some embodiments. Accordingly, at 602, the method 600 may include retrieving, using the storage device, a gameplay data based on the initiating from the distributed ledger. Further, the gameplay data may include a gameplay session information associated with the gameplay session of the at least one player playing the game. Further, the gameplay session information may include a gaming instance information associated with a gaming instance or situation during the playing of the game. Further, at 604, the method 600 may include transmitting, using the communication device, the gameplay data to the at least one player device. Further, at 606, the method 600 may include receiving, using the communication device, at least one gaming response associated with gameplay data from the at least one player device. Further, the at least one gaming response may include a player game move performed by the at least one player according to the gaming instance. Further, at 608, the method 600 may include analyzing, using the processing device, the at least one gaming response and the gameplay data. Further, at 610, the method 600 may include determining, using the processing device, a gameplay result associated with the gameplay session based on the analyzing of the at least one gaming response and the gameplay data. Further, the gaming result may include a winner, a loser, etc. Further, the gaming result may include at least one reward for the at least one player (or the winner). Further, at 612, the method 600 may include transmitting, using the communication device, the gameplay result to the at least one player device.

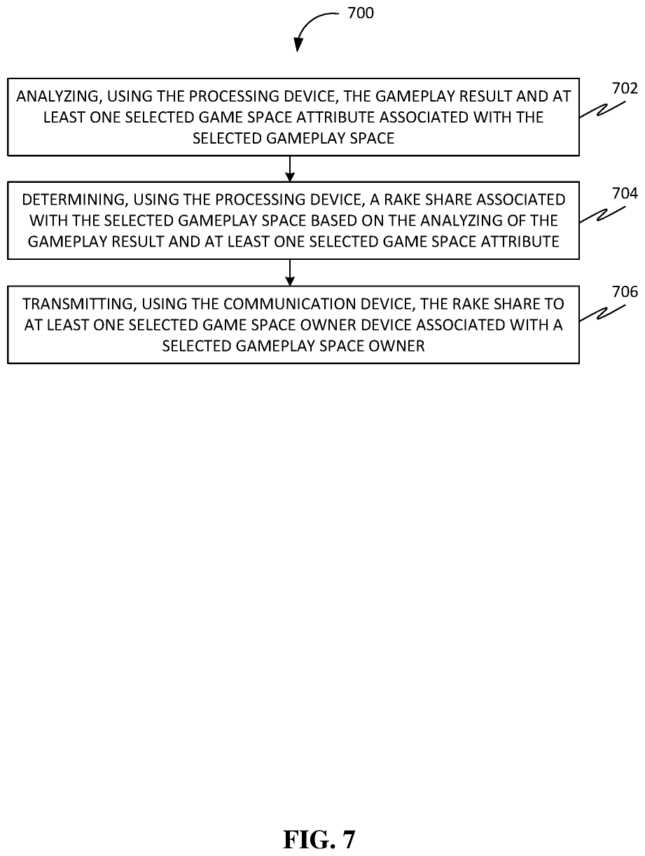

FIG. 7 is a flow chart of a method 700 of facilitating personalizing a gameplay, in accordance with some embodiments. Accordingly, at 702, the method 700 may include analyzing, using the processing device, the gameplay result and at least one selected game space attribute associated with the selected game space. Further, the at least one selected game space attribute represents a level of personalization of the selected game space. Further, at 704, the method 700 may include determining, using the processing device, a rake share associated with the selected game space based on the analyzing of the gameplay result and at least one selected game space attribute. Further, the rake share may include a revenue (or scaled commission fee) generated for playing the game in the personalized game space owned by the game space owner. Further, at 706, the method 700 may include transmitting, using the communication device, the rake share to at least one selected game space owner device (such as at least one selected game space owner device 1302) associated with a selected game space owner. Further, the selected game space owner owns the selected game space.

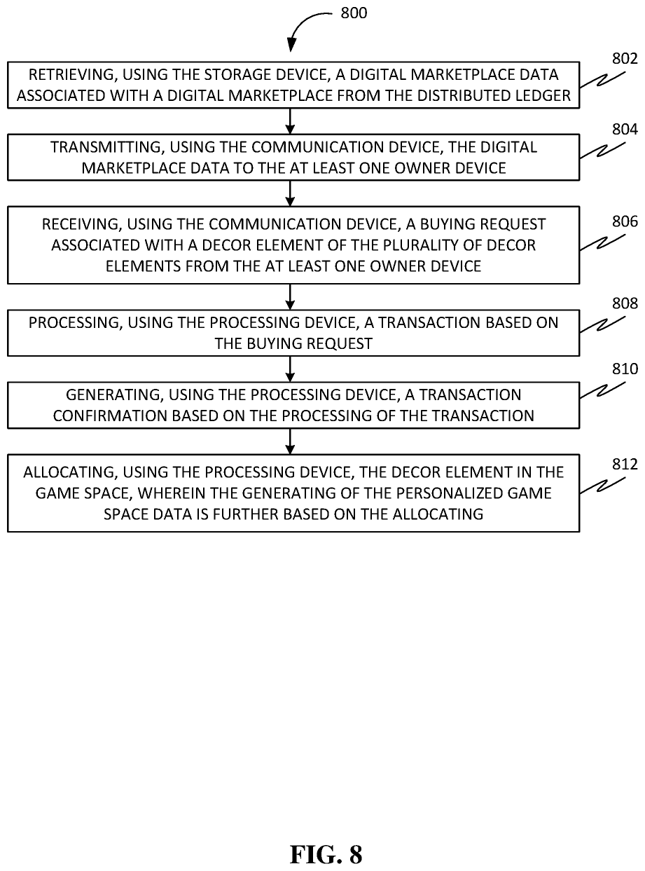

FIG. 8 is a flow chart of a method 800 of facilitating personalizing a gameplay, in accordance with some embodiments. Accordingly, the plurality of game assets may include a plurality of decor elements disposed in the game space. Further, at 802, the method 800 may include retrieving, using the storage device, a digital marketplace data associated with a digital marketplace from the distributed ledger. Further, the digital marketplace data may include a catalog of a plurality of non fungible tokens representing the plurality of decor elements. Further, the plurality of decor elements may include components or devices used to personalize the game space to enhance the ambience of the game space. Further, the plurality of decor elements may include a scenery, a decorative light, a showpiece, etc. Further, at 804, the method 800 may include transmitting, using the communication device, the digital marketplace data to the at least one owner device. Further, at 806, the method 800 may include receiving, using the communication device, a buying request associated with a decor element of the plurality of decor elements from the at least one owner device. Further, the buying request may include an NFT identifier corresponding to the decor element. Further, the buying request may include a payment information for making a payment for a cost of the decor element. Further, at 808, the method 800 may include processing, using the processing device, a transaction based on the buying request. Further, at 810, the method 800 may include generating, using the processing device, a transaction confirmation based on the processing of the transaction. Further, at 812, the method 800 may include allocating, using the processing device, the decor element in the game space based on the transaction confirmation. Further, the generating of the personalized game space data may be based on the allocating.

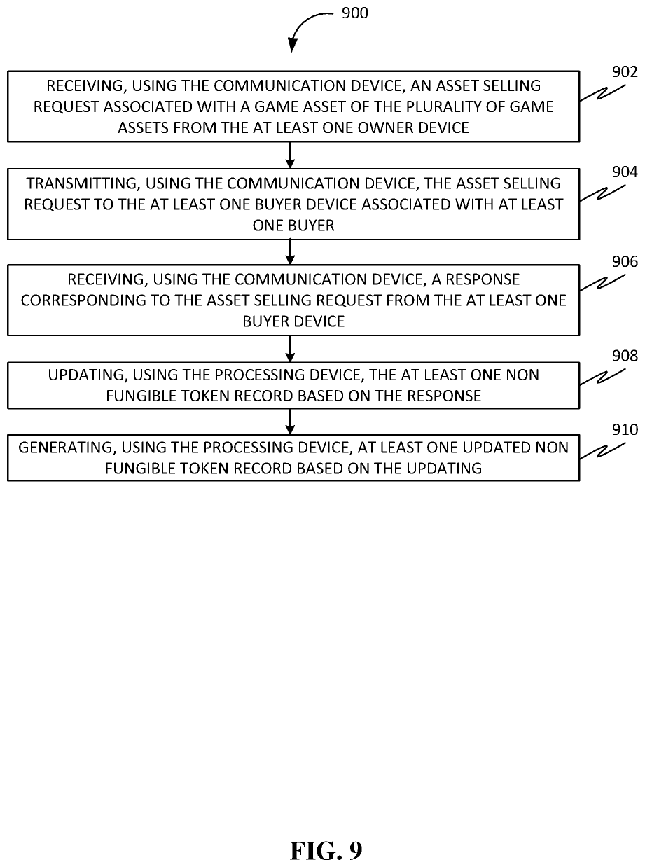

FIG. 9 is a flow chart of a method 900 of facilitating personalizing a gameplay, in accordance with some embodiments. Accordingly, at 902, the method 900 may include receiving, using the communication device, an asset selling request associated with an asset of the plurality of game assets from the at least one owner device. Further, the asset selling request may include an asset identifier corresponding to the asset to be sold by the at least one owner. Further, at 904, the method 900 may include transmitting, using the communication device, the asset selling request to at least one buyer device (such as at least one buyer device 1402) associated with at least one buyer. Further, the at least one buyer may include an individual. Further, at 906, the method 900 may include receiving, using the communication device, a response corresponding to the asset selling request from the at least one buyer device. Further, the at least one buyer device may include a computing device, a client device, an input device, an output device, etc. Further, the response indicates a willingness of the at least one buyer to buy the asset. Further, at 908, the method 900 may include updating, using the processing device, the at least one non fungible token record based on the response. Further, at 910, the method 900 may include generating, using the processing device, at least one updated non fungible token record based on the updating. Further, the at least one non fungible token record may include the at least one updated non fungible token record.

Further, in some embodiments, the plurality of game assets may include a plurality of decor elements and a plurality of gameplay elements. Further, the plurality of gameplay elements may be used during the gameplay. Further, the plurality of decor elements may be disposed in the game space.

Further, in some embodiments, the game comprises a card game. Further, the card game may include a poker game.

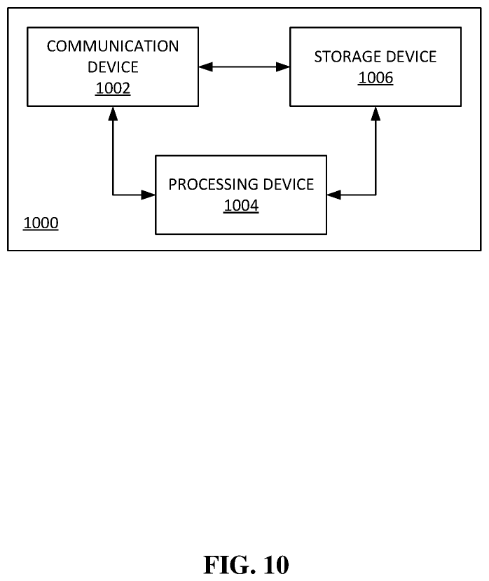

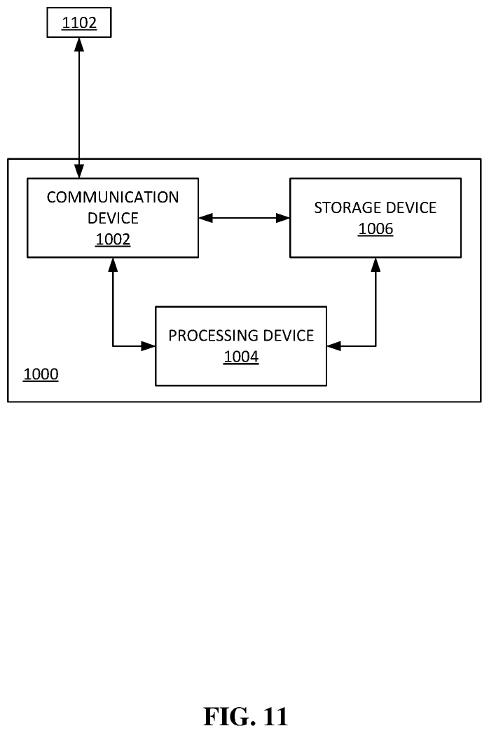

FIG. 10 is a block diagram of a system 1000 of facilitating personalizing a gameplay, in accordance with some embodiments. Accordingly, the system 1000 may include a communication device 1002 configured for receiving a game request from at least one owner device 1102 (as shown in FIG. 11) associated with a game space owner. Further, the game space owner owns a game space for allowing playing of a game. Further, the communication device 1002 may be configured for transmitting a personalized game space data to the at least one owner device 1102.

Further, the system 1000 may include a processing device 1004 communicatively coupled with the communication device 1002. Further, the processing device 1004 may be configured for generating at least one gaming user interface based on the game request. Further, the at least one gaming user interface presents the game space to the first user. Further, the game space may include a virtual representation of the game. Further, the virtual representation may include a plurality of game assets. Further, the processing device 1004 may be configured for obtaining at least one personalization information associated with at least one of the game space owner and at least one player. Further, the at least one player plays the game in the game space. Further, the processing device 1004 may be configured for generating at least one non fungible token record representing at least one non fungible token associated with the plurality of game assets. Further, the at least one non fungible token record may include a personalized digital representation of the plurality of game assets. Further, the processing device 1004 may be configured for generating the personalized game space data based on the at least one non fungible token record. Further, the personalized game space data corresponds to a personalized game space that may include the plurality of game assets customized according to the at least one personalization information.

Further, the system 1000 may include a storage device 1006 communicatively coupled with the processing device 1004. Further, the storage device 1006 may be configured for storing the personalized game space data in a distributed ledger.

Further, in some embodiments, the communication device 1002 may be configured for receiving at least one personalization indication corresponding to a game asset of the plurality of game assets from the at least one owner device 1102. Further, the at least one personalization indication comprises a personalization information associated with the game asset. Further, the communication device 1002 may be configured for transmitting at least one personalized asset representation to the at least one owner device 1102. Further, the communication device 1002 may be configured for receiving a selection corresponding to the at least one personalized asset representation from the at least one owner device 1102. Further, the obtaining of the at least one personalization information may be based on the selection. Further, the storage device 1006 may be configured for retrieving the at least one personalized asset representation associated with the game asset based on the at least one personalization indication.

Further, in some embodiments, the plurality of game assets may include at least one modifiable asset and at least one unmodifiable asset.

Further, in some embodiments, the personalized game space data may include a plurality of asset information associated with each of the plurality of game assets. Further, the plurality of asset information may include the at least one non fungible token record. Further, the at least one non fungible token record may include a rarity information associated with each of the at least one non fungible token. Further, the processing device 1004 may be configured for analyzing the plurality of asset information. Further, the processing device 1004 may be configured for determining at least one game space attribute associated with the game space based on the analyzing of the plurality of asset information. Further, the storage device 1006 may be configured for storing the at least one game space attribute in the distributed ledger.

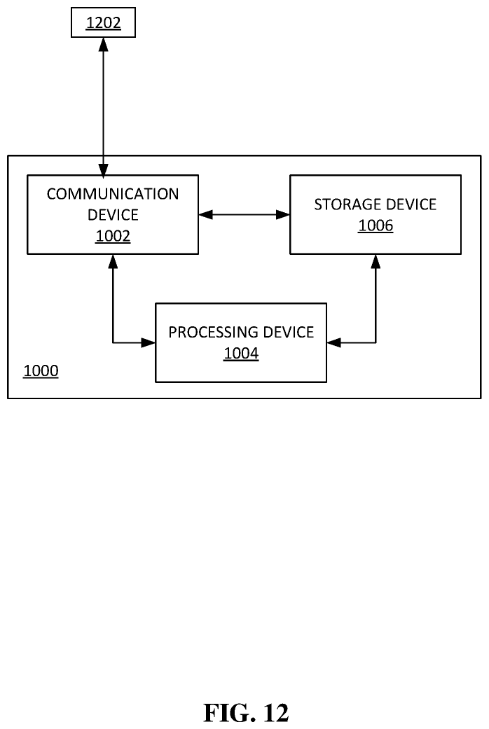

Further, in some embodiments, the communication device 1002 may be configured for receiving at least one player gameplay request from at least one player device 1202 (as shown in FIG. 12) associated with at least one player. Further, the at least one player gameplay request indicates a willingness of the at least one player to play the game. Further, the processing device 1004 may be configured for authenticating the at least one player based on the at least one player gameplay request. Further, the processing device 1004 may be configured for analyzing a plurality of game space attributes. Further, the processing device 1004 may be configured for selecting a selected game space from a plurality of game spaces based on the analyzing. Further, the processing device 1004 may be configured for initiating a gameplay session in the selected game space based on the selecting. Further, the gameplay session allows the at least one player to play the game in the selected game space. Further, the storage device 1006 is configured for retrieving the plurality of game space attributes associated with a plurality of game spaces from the distributed ledger based on the authenticating of the at least one player. Further, each of the plurality of game space attributes represents a level of personalization of the each of the plurality of game spaces. Further, in some embodiments, the storage device 1006 may be configured for retrieving a gameplay data based on the initiating from the distributed ledger. Further, the gameplay data may include a gameplay session information associated with the gameplay session of the at least one player playing the game. Further, the communication device 1002 may be configured for transmitting the gameplay data to the at least one player device 1202. Further, the communication device 1002 may be configured for receiving at least one gaming response associated with gameplay data from the at least one player device 1202. Further, the communication device 1002 may be configured for transmitting a gameplay result to the at least one player device 1202. Further, the processing device 1004 may be configured for analyzing the at least one gaming response and the gameplay data. Further, the processing device 1004 may be configured for determining the gameplay result associated with the gameplay session based on the analyzing of the at least one gaming response and the gameplay data.

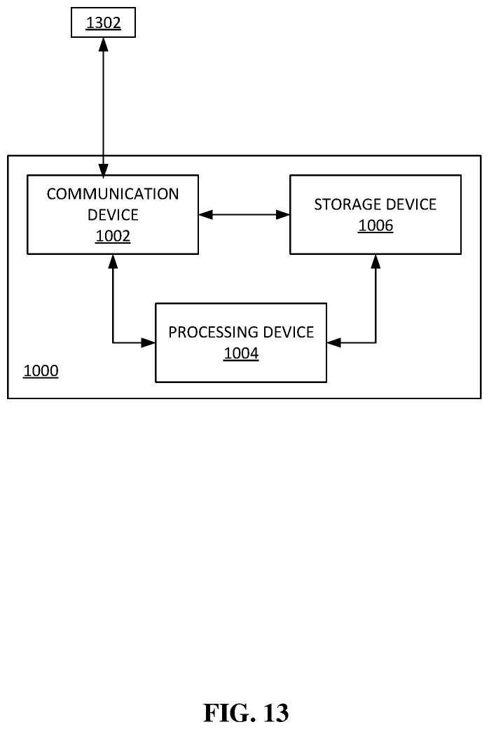

Further, in some embodiments, the processing device 1004 may be configured for analyzing the gameplay result and at least one selected game space attribute associated with the selected game space. Further, the at least one selected game space attribute represents a level of personalization of the selected game space. Further, the processing device 1004 may be configured for determining a rake share associated with the selected game space based on the analyzing of the gameplay result and at least one selected game space attribute. Further, the communication device 1002 may be configured for transmitting the rake share to at least one selected game space owner device 1302 (as shown in FIG. 13) associated with a selected game space owner. Further, the selected game space owner owns the selected game space.

Further, in some embodiments, the plurality of game assets may include a plurality of decor elements disposed in the game space. Further, the storage device 1006 may be configured for retrieving a digital marketplace data associated with a digital marketplace from the distributed ledger. Further, the digital marketplace data may include a catalog of a plurality of non fungible tokens representing the plurality of decor elements. Further, the communication device 1002 may be configured for transmitting the digital marketplace data to the at least one owner device 1102. Further, the communication device 1002 may be configured for receiving a buying request associated with a decor element of the plurality of decor elements from the at least one owner device 1102. Further, the buying request may include an NFT identifier corresponding to the decor element. Further, the buying request may include a payment information (such as UPI address, credit card details, debit card details, etc.) for making a payment for a cost of the decor element. Further, the processing device 1004 may be configured for processing a transaction based on the buying request. Further, the processing device 1004 may be configured for generating a transaction confirmation based on the processing of the transaction. Further, the transaction confirmation may indicate successful buying of the decor element. Further, the processing device 1004 may be configured for allocating the decor element in the game space based on the transaction confirmation. Further, the generating of the personalized game space data may be based on the allocating.

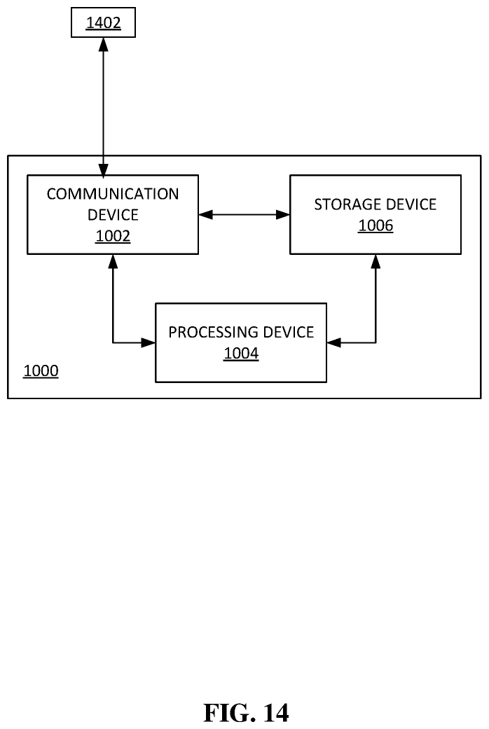

Further, in some embodiments, the communication device 1002 may be configured for receiving an asset selling request associated with an asset of the plurality of game assets from the at least one owner device 1102. Further, the asset selling request may include an asset identifier corresponding to the asset. Further, the communication device 1002 may be configured for transmitting the asset selling request to at least one buyer device 1402 (as shown in FIG. 14) associated with at least one buyer. Further, the communication device 1002 may be configured for receiving a response corresponding to the asset selling request from the at least one buyer device 1402. Further, the response indicates a willingness of the at least one buyer to buy the asset. Further, the processing device 1004 may be configured for updating the at least one non fungible token record based on the response. Further, the processing device 1004 may be configured for generating at least one updated non fungible token record based on the updating. Further, the at least one non fungible token record may include the at least one updated non fungible token record.

Further, in some embodiments, the plurality of game assets may include a plurality of decor elements and a plurality of gameplay elements. Further, the plurality of gameplay elements may be used during the gameplay. Further, the plurality of decor elements may be disposed in the game space.

FIG. 11 is a block diagram of the system 1000 of facilitating personalizing the gameplay, in accordance with some embodiments.

FIG. 12 is a block diagram of the system 1000 of facilitating personalizing the gameplay, in accordance with some embodiments.

FIG. 13 is a block diagram of the system 1000 of facilitating personalizing the gameplay, in accordance with some embodiments.

FIG. 14 is a block diagram of the system 1000 of facilitating personalizing the gameplay, in accordance with some embodiments.

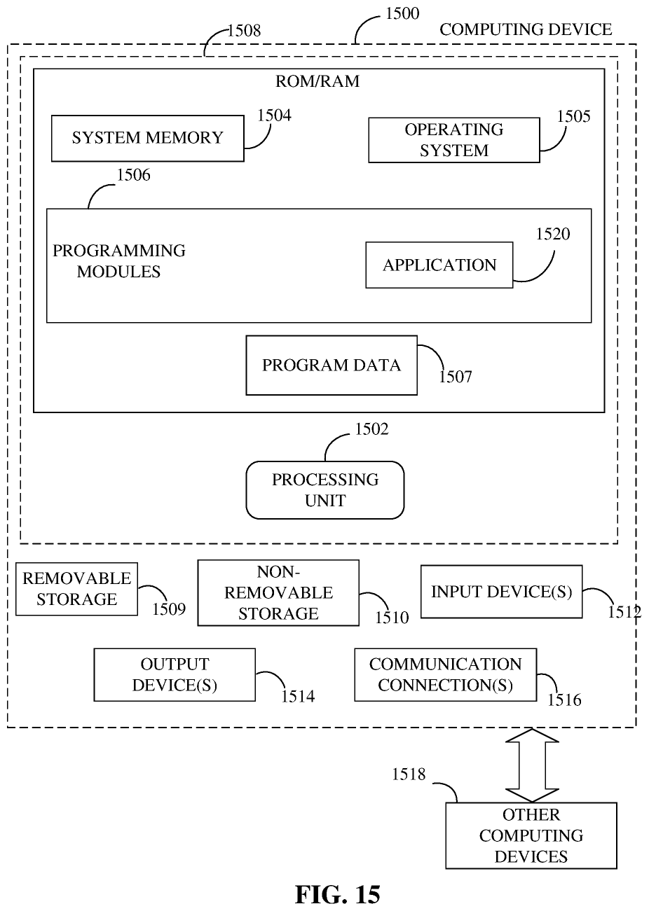

With reference to FIG. 15, a system consistent with an embodiment of the disclosure may include a computing device or cloud service, such as computing device 1500. In a basic configuration, computing device 1500 may include at least one processing unit 1502 and a system memory 1504. Depending on the configuration and type of computing device, system memory 1504 may comprise, but is not limited to, volatile (e.g. random-access memory (RAM)), non-volatile (e.g. read-only memory (ROM)), flash memory, or any combination. System memory 1504 may include operating system 1505, one or more programming modules 1506, and may include a program data 1507. Operating system 1505, for example, may be suitable for controlling computing device 1500's operation. In one embodiment, programming modules 1506 may include image-processing module, machine learning module. Furthermore, embodiments of the disclosure may be practiced in conjunction with a graphics library, other operating systems, or any other application program and is not limited to any particular application or system. This basic configuration is illustrated in FIG. 15 by those components within a dashed line 1508.

Computing device 1500 may have additional features or functionality. For example, computing device 1500 may also include additional data storage devices (removable and/or non-removable) such as, for example, magnetic disks, optical disks, or tape. Such additional storage is illustrated in FIG. 15 by a removable storage 1509 and a non-removable storage 1510. Computer storage media may include volatile and non-volatile, removable and non-removable media implemented in any method or technology for storage of information, such as computer-readable instructions, data structures, program modules, or other data. System memory 1504, removable storage 1509, and non-removable storage 1510 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 1500. Any such computer storage media may be part of device 1500. Computing device 1500 may also have input device(s) 1512 such as a keyboard, a mouse, a pen, a sound input device, a touch input device, a location sensor, a camera, a biometric sensor, etc. Output device(s) 1514 such as a display, speakers, a printer, etc. may also be included. The aforementioned devices are examples and others may be used.

Computing device 1500 may also contain a communication connection 1516 that may allow device 1500 to communicate with other computing devices 1518, such as over a network in a distributed computing environment, for example, an intranet or the Internet. Communication connection 1516 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both storage media and communication media.

As stated above, a number of program modules and data files may be stored in system memory 1504, including operating system 1505. While executing on processing unit 1502, programming modules 1506 (e.g., application 1520) may perform processes including, for example, one or more stages of methods, algorithms, systems, applications, servers, databases as described above. The aforementioned process is an example, and processing unit 1502 may perform other processes. Other programming modules that may be used in accordance with embodiments of the present disclosure may include machine learning applications.

Generally, consistent with embodiments of the disclosure, program modules may include routines, programs, components, data structures, and other types of structures that may perform particular tasks or that may implement particular abstract data types. Moreover, embodiments of the disclosure may be practiced with other computer system configurations, including hand-held devices, general purpose graphics processor-based systems, multiprocessor systems, microprocessor-based or programmable consumer electronics, application specific integrated circuit-based electronics, minicomputers, mainframe computers, and the like. Embodiments of the disclosure may also be practiced in distributed computing environments where tasks are performed by remote processing devices that are linked through a communications network. In a distributed computing environment, program modules may be located in both local and remote memory storage devices.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general-purpose computer or in any other circuits or systems.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random-access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, solid state storage (e.g., USB drive), or a CD-ROM, a carrier wave from the Internet, or other forms of RAM or ROM. Further, the disclosed methods' stages may be modified in any manner, including by reordering stages and/or inserting or deleting stages, without departing from the disclosure.

Although the present disclosure has been explained in relation to its preferred embodiment, it is to be understood that many other possible modifications and variations can be made without departing from the spirit and scope of the disclosure.

The following is claimed:

1. A method of facilitating personalizing a gameplay, the method comprising:
receiving, using a communication device, a game request from at least one owner device associated with a game space owner, wherein the game space owner owns a game space for allowing playing of a game;
generating, using a processing device, at least one gaming user interface based on the game request, wherein the at least one gaming user interface presents the game space to the game space owner, wherein the game space comprises a virtual representation of the game, wherein the virtual representation comprises a plurality of game assets;
obtaining, using the processing device, at least one personalization information associated with at least one of the game space owner and at least one player, wherein the at least one player plays the game in the game space;
generating, using the processing device, at least one non fungible token record representing at least one non fungible token (NFT) associated with the plurality of game assets, wherein the at least one non fungible token record comprises a personalized digital representation of the plurality of game assets;
generating, using the processing device, a personalized game space data based on the at least one non fungible token record, wherein the personalized game space data corresponds to a personalized game space comprising the plurality of game assets customized according to the at least one personalization information;
transmitting, using the communication device, the personalized game space data to the at least one owner device; and
storing, using a storage device, the personalized game space data in a distributed ledger.

2. The method of claim 1 further comprises:
receiving, using the communication device, at least one personalization indication corresponding to a game asset of the plurality of game assets from the at least one owner device, wherein the at least one personalization indication comprises a personalization information associated with the game asset;
retrieving, using the storage device, at least one personalized asset representation associated with the game asset based on the at least one personalization indication;
transmitting, using the communication device, the at least one personalized asset representation to the at least one owner device; and
receiving, using the communication device, a selection corresponding to the at least one personalized asset representation from the at least one owner device, wherein the obtaining of the at least one personalization information is further based on the selection.

3. The method of claim 1, wherein the plurality of game assets comprises at least one modifiable asset and at least one unmodifiable asset.

4. The method of claim 1, wherein the personalized game space data comprises a plurality of asset information associated with each of the plurality of game assets, wherein the plurality of asset information comprises the at least one non fungible token record, wherein the at least one non fungible token record comprises a rarity information associated with each of the at least one non fungible token, wherein the method further comprises:
analyzing, using the processing device, the plurality of asset information;
determining, using the processing device, at least one game space attribute associated with the game space based on the analyzing of the plurality of asset information; and
storing, using the storage device, the at least one game space attribute in the distributed ledger.

5. The method of claim 4 further comprising:
receiving, using the communication device, at least one player gameplay request from at least one player device associated with the at least one player, wherein the at least one player gameplay request indicates a willingness of the at least one player to play the game;
authenticating, using the processing device, the at least one player based on the at least one player gameplay request;
retrieving, using the storage device, a plurality of game space attributes associated with a plurality of game spaces from the distributed ledger based on the authenticating of the at least one player, wherein each of the plurality of game space attributes represents a level of personalization of the each of the plurality of game spaces;
analyzing, using the processing device, the plurality of game space attributes;
selecting, using the processing device, a selected game space from a plurality of game spaces based on the analyzing; and
initiating, using the processing device, a gameplay session in the selected game space based on the selecting, wherein the gameplay session allows the at least one player to play the game in the selected game space.

6. The method of claim 5 further comprising:
retrieving, using the storage device, a gameplay data based on the initiating from the distributed ledger, wherein the gameplay data comprises a gameplay session information associated with the gameplay session of the at least one player playing the game;
transmitting, using the communication device, the gameplay data to the at least one player device;
receiving, using the communication device, at least one gaming response associated with the gameplay data from the at least one player device;
analyzing, using the processing device, the at least one gaming response and the gameplay data;
determining, using the processing device, a gameplay result associated with the gameplay session based on the analyzing of the at least one gaming response and the gameplay data; and
transmitting, using the communication device, the gameplay result to the at least one player device.

7. The method of claim 6 further comprising:
analyzing, using the processing device, the gameplay result and at least one selected game space attribute associated with the selected game space, wherein the at least one selected game space attribute represents a level of personalization of the selected game space;
determining, using the processing device, a rake share associated with the selected game space based on the analyzing of the gameplay result and at least one selected game space attribute; and
transmitting, using the communication device, the rake share to at least one selected game space owner device associated with a selected game space owner, wherein the selected game space owner owns the selected game space.

8. The method of claim 1, wherein the plurality of game assets comprises a plurality of decor elements disposed in the game space, wherein the method further comprises:
retrieving, using the storage device, a digital marketplace data associated with a digital marketplace from the distributed ledger, wherein the digital marketplace data comprises a catalog of a plurality of non fungible tokens (NFTs) representing the plurality of decor elements;
transmitting, using the communication device, the digital marketplace data to the at least one owner device;
receiving, using the communication device, a buying request associated with a decor element of the plurality of decor elements from the at least one owner device, wherein the buying request comprises a non fungible token (NFT) identifier corresponding to the decor element;
processing, using the processing device, a transaction based on the buying request;
generating, using the processing device, a transaction confirmation based on the processing of the transaction; and
allocating, using the processing device, the decor element in the game space based on the transaction confirmation, wherein the generating of the personalized game space data is further based on the allocating.

9. The method of claim 1 further comprising:
receiving, using the communication device, an asset selling request associated with a game asset of the plurality of game assets from the at least one owner device, wherein the asset selling request comprises an asset identifier corresponding to the game asset to be sold by the at least one owner;
transmitting, using the communication device, the asset selling request to at least one buyer device associated with at least one buyer;
receiving, using the communication device, a response corresponding to the asset selling request from the at least one buyer device, wherein the response indicates a willingness of the at least one buyer to buy the game asset;
updating, using the processing device, the at least one non fungible token record based on the response; and
generating, using the processing device, at least one updated non fungible token record based on the updating, wherein the at least one non fungible token record comprises the at least one updated non fungible token record.

10. The method of claim 1, wherein the plurality of game assets comprises a plurality of decor elements and a plurality of gameplay elements, wherein the plurality of gameplay elements is used during the gameplay, wherein the plurality of decor elements is disposed in the game space.

11. A system of facilitating personalizing a gameplay, the system comprising:
a communication device configured for:
receiving a game request from at least one owner device associated with a game space owner, wherein the game space owner owns a game space for allowing playing of a game; and
transmitting a personalized game space data to the at least one owner device;
a processing device communicatively coupled with the communication device, wherein the processing device is configured for:
generating at least one gaming user interface based on the game request, wherein the at least one gaming user interface presents the game space to the first user, wherein the game space comprises a virtual representation of the game, wherein the virtual representation comprises a plurality of game assets;
obtaining at least one personalization information associated with at least one of the game space owner and at least one player, wherein the at least one player plays the game in the game space;
generating at least one non fungible token record representing at least one non fungible token associated with the plurality of game assets, wherein the at least one non fungible token record comprises a personalized digital representation of the plurality of game assets; and
generating the personalized game space data based on the at least one non fungible token record, wherein the personalized game space data corresponds to a personalized game space comprising the plurality of game assets customized according to the at least one personalization information; and
a storage device communicatively coupled with the processing device, wherein the storage device is configured for storing the personalized game space data in a distributed ledger.

12. The system of claim 11, wherein the communication device is further configured for:
receiving at least one personalization indication corresponding to a game asset of the plurality of game assets from the at least one owner device, wherein the at least one personalization indication comprises a personalization information associated with the game asset;
transmitting at least one personalized asset representation to the at least one owner device; and
receiving a selection corresponding to the at least one personalized asset representation from the at least one owner device, wherein the obtaining of the at least one personalization information is further based on the selection, wherein the storage device is configured for retrieving the at least one personalized asset representation associated with the game asset based on the at least one personalization indication.

13. The system of claim 11, wherein the plurality of game assets comprises at least one modifiable asset and at least one unmodifiable asset.

14. The system of claim 11, wherein the personalized game space data comprises a plurality of asset information associated with each of the plurality of game assets, wherein the plurality of asset information comprises the at least one non fungible token record, wherein the at least one non fungible token record comprises a rarity information associated with each of the at least one non fungible token, wherein the processing device is configured for:
analyzing the plurality of asset information; and
determining at least one game space attribute associated with the game space based on the analyzing of the plurality of asset information, wherein the storage device is configured for storing the at least one game space attribute in the distributed ledger.

15. The system of claim 14, wherein the communication device is configured for receiving at least one player gameplay request from at least one player device associated with the at least one player, wherein the at least one player gameplay request indicates a willingness of the at least one player to play the game, wherein the processing device is configured for:
authenticating the at least one player based on the at least one player gameplay request;
analyzing a plurality of game space attributes;
selecting a selected game space from a plurality of game spaces based on the analyzing; and
initiating a gameplay session in the selected game space based on the selecting, wherein the gameplay session allows the at least one player to play the game in the selected game space, wherein the storage device is configured for retrieving the plurality of game space attributes associated with a plurality of game spaces from the distributed ledger based on the authenticating of the at least one player, wherein each of the plurality of game space attributes represents a level of personalization of the each of the plurality of game spaces.

16. The system of claim 15, wherein the storage device is configured for retrieving a gameplay data based on the initiating from the distributed ledger, wherein the gameplay data comprises a gameplay session information associated with the gameplay session of the at least one player playing the game, wherein the communication device is configured for:
transmitting the gameplay data to the at least one player device;
receiving at least one gaming response associated with the gameplay data from the at least one player device; and
transmitting a gameplay result to the at least one player device, wherein the processing device is configured for:
analyzing the at least one gaming response and the gameplay data; and
determining the gameplay result associated with the gameplay session based on the analyzing of the at least one gaming response and the gameplay data.

17. The system of claim 16, wherein the processing device is configured for:
analyzing the gameplay result and at least one selected game space attribute associated with the selected game space, wherein the at least one selected game space attribute represents a level of personalization of the selected game space; and
determining a rake share associated with the selected game space based on the analyzing of the gameplay result and at least one selected game space attribute, wherein the communication device is configured for transmitting the rake share to at least one selected game space owner device associated with a selected game space owner, wherein the selected game space owner owns the selected game space.

18. The system of claim 11, wherein the plurality of game assets comprises a plurality of decor elements disposed in the game space, wherein the storage device is configured for retrieving a digital marketplace data associated with a digital marketplace from the distributed ledger, wherein the digital marketplace data comprises a catalog of a plurality of non fungible tokens representing the plurality of decor elements, wherein the communication device is configured for:
transmitting the digital marketplace data to the at least one owner device; and
receiving a buying request associated with a decor element of the plurality of decor elements from the at least one owner device, wherein the buying request comprises a non fungible token (NFT) identifier corresponding to the decor element, wherein the processing device is configured for:
processing a transaction based on the buying request;
generating a transaction confirmation based on the processing of the transaction; and
allocating the decor element in the game space based on the transaction confirmation, wherein the generating of the personalized game space data is further based on the allocating.

19. The system of claim 11, wherein the communication device is configured for:
receiving an asset selling request associated with a game asset of the plurality of game assets from the at least one owner device, wherein the asset selling request comprises an asset identifier corresponding to the game asset;
transmitting the asset selling request to at least one buyer device associated with at least one buyer; and
receiving a response corresponding to the asset selling request from the at least one buyer device, wherein the response indicates a willingness of the at least one buyer to buy the asset, wherein the processing device is configured for:
updating the at least one non fungible token record based on the response; and
generating at least one updated non fungible token record based on the updating, wherein the at least one non fungible token record comprises the at least one updated non fungible token record.

20. The system of claim 11, wherein the plurality of game assets comprises a plurality of decor elements and a plurality of gameplay elements, wherein the plurality of gameplay elements is used during the gameplay, wherein the plurality of decor elements is disposed in the game space.
